(19) United States
(12) Patent Application Publication
(10) Pub. No.: US 2005/0146442 A1
(43) Pub. Date: Jul. 7, 2005

(54) Combined structure of a light source and fire-resistant lining board

(76) Inventor: Shao-Lun Chen, Hsinchu City (TW)

Correspondence Address: Shao-Lun Chen, PO Box 82-144, Taipei, TW

(21) Appl. No.: 10/745,503

(22) Filed: Dec. 29, 2003

(51) Int. Cl. G08B 3/00

(52) U.S. Cl. 340/815.45

(57) ABSTRACT

The present invention relates to a combined structure of a light source and fire-resistant lining board. The lining board is elongated and LED is employed as light source, which is operated with a low voltage and low current source. A buzzer and a control box switch are positioned between a light source and the output end of the current source. The lining board is optionally bent and has multi-section uninterrupted flashing effect. The LED is mounted at the recess of the lining board or the panel or sideboard at the emergency exists to indicate direction or object. The noise of the buzzer assists in indicating the emergency route and exist.

### BACKGROUND OF THE INVENTION

The present invention relates to a combined structure of a light source and fire-resistant lining board, and in particular, a lining board with a transparent rubber strap enclosed LED, which operated under low current and voltage. The rubber strap can be flexibly bent to suit the configuration of the lining board.

### SUMMARY OF THE INVENTION

Accordingly, it is an object of the present invention to provide a combined structure of a light source and fire-resistant lining board having a bottom recess, operated with a 24V low current and low voltage and LED being employed as light source, characterized in that a transparent rubber strap covers the LED and is elongated which can be bent optionally, a buzzer is positioned between a light source and the current source, and the bottom recess of the fire-resistant lining board contains the LED and the LED is then covered with a transparent external cover by means of engaging peg and engaging slot or protruded peg and recess, the LED produced brightness to cause an ornamental object to be seen and the buzzer assists in alarming the direction of exist to a safer site.

Yet another object of the present invention is to provide a combined structure of a light source and fire-resistance lining board, wherein a low voltage of below 24V is employed as the power source to operate the lining board.

Still another object of the present invention is to provide a combined structure of a light source and fire-resistance lining board, wherein the LED is enclosed with a transparent, fire-resistant rubber tube which can be immersed under water without current leakage.

Yet another object of the present invention is to provide a combined structure of a light source and fire-resistance lining board, wherein the lining board can be bent and is also employed as sign board and indication.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1 to 6 indicate a combined structure of a light source and fire-resistant lining board in accordance with the present invention.

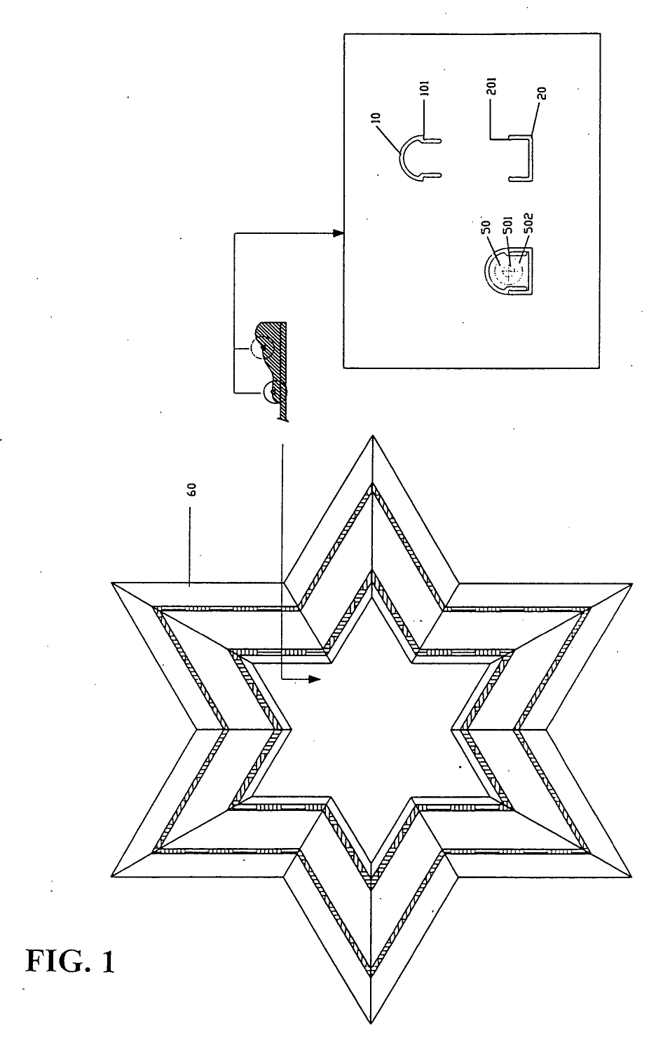

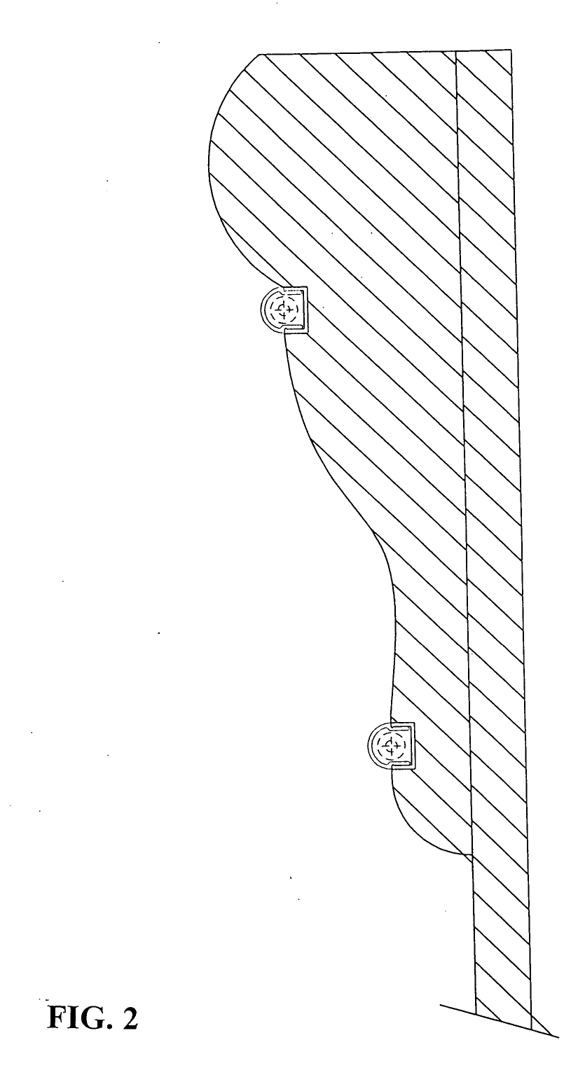

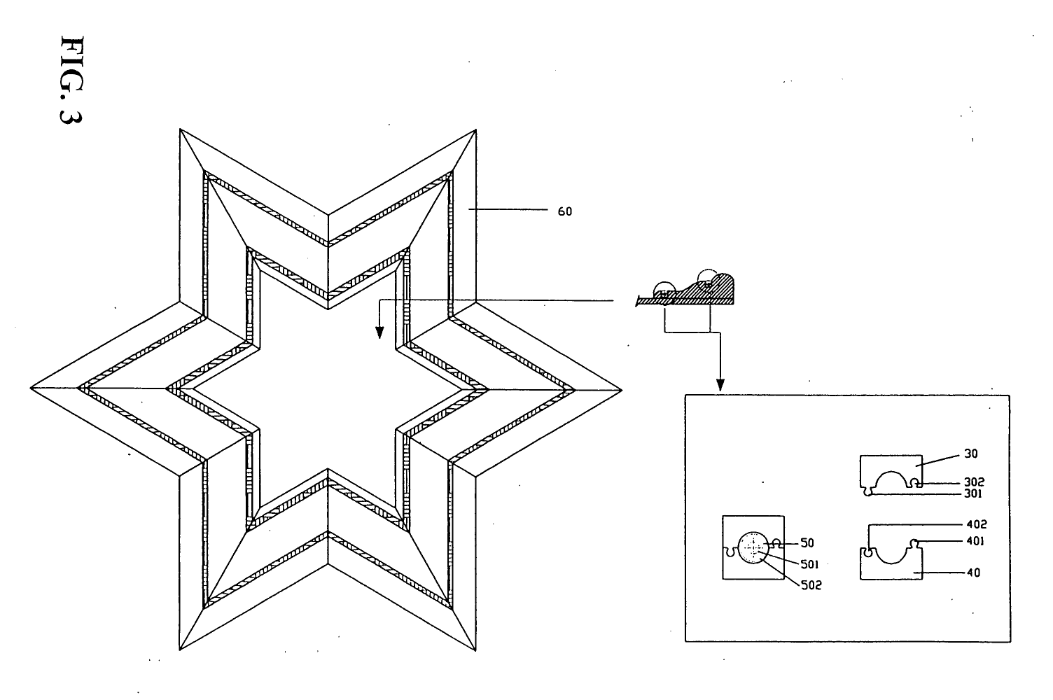

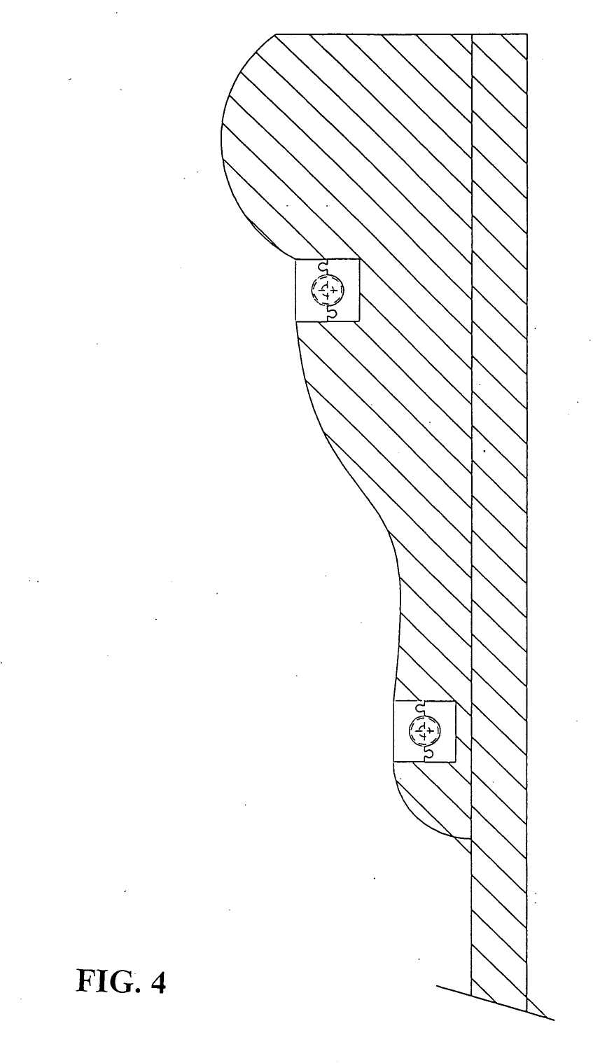

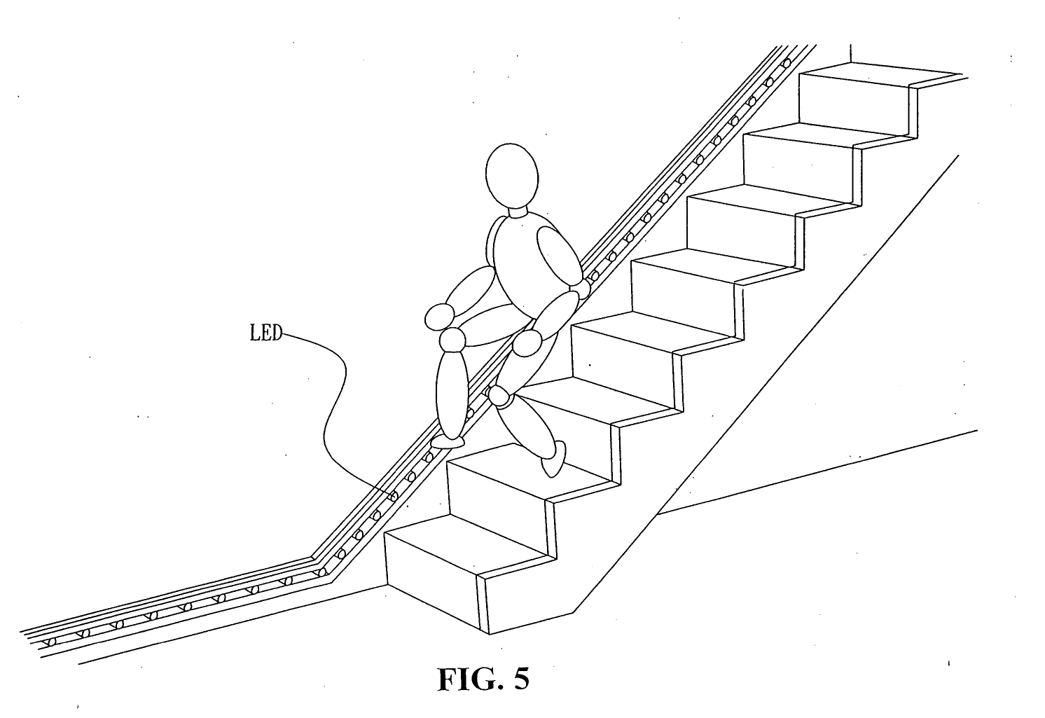

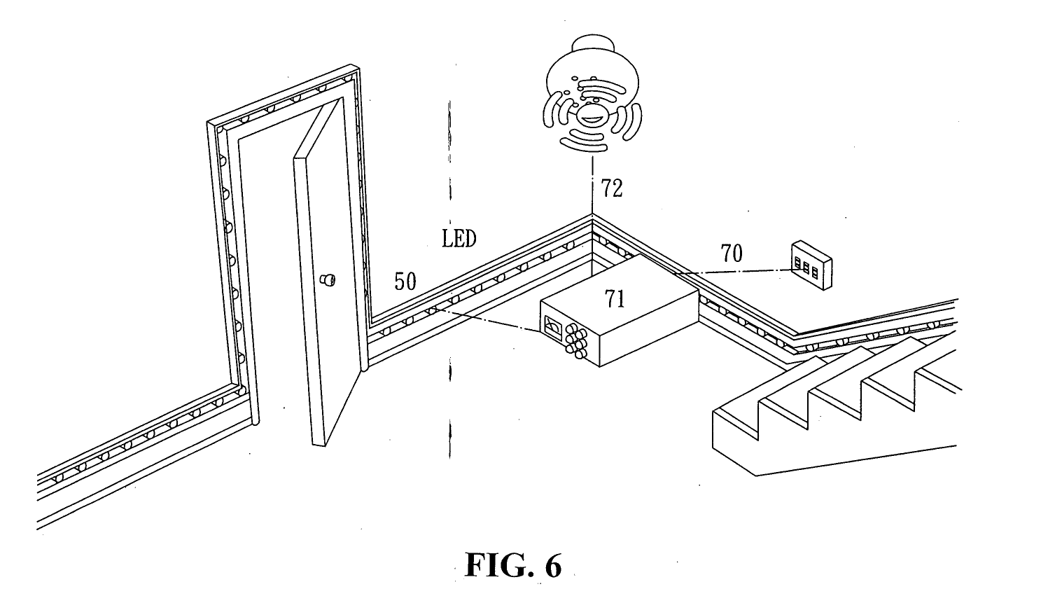

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

As shown in these figures, LED 502 is enclosed by a transparent tube 501 to form into an elongated lighting strap 50. The length of the strap 50 is designed in accordance with requirement. For decorative pattern 60, for example, a bottom recess 20 of lining board is designed. The upper edge at the inner side of the bottom recess 20 is provided with a peg 201, and the hollow space at the interior of the bottom recess 20 is adapted to hold the lighting strap 50 of various shapes. The top cover 10 is a transparent covering body having two sides mounted with engaging slot 101 for engagement with the engaging peg 201 at the bottom recess 20. When the lighting strap 50 is positioned within the bottom recess 20 and is then covered with the top cover 10, the peg 201 and the engaging slot 101 are fastened to each other and the lighting strap is position between the two components. The brightness of the LED 502 can pass through the transparent top cover 10 and the ornamental design is thus becoming very significant.

The side ends at the upper edge of the bottom recess 40 have a protruded peg 401 at one end and the other end being a recess 402. The external cover 30 is a transparent covering, and the bottom edge and the protruded peg 401 of the bottom recess 40 are respectively engaged with the recess 302 and the protruded peg 301. Thus, the lighting strap 50 is mounted to the bottom recess 40 and is covered. The power source end of the lighting strap 50 has an uninterrupted and multi-section flashing control box 71 which can continuously provide light source even when the power supply is cut off. The light source can be switched to a flickering light using a switch.

In accordance with the present invention, the buzzer 72 is positioned between the light source of the lighting strap 50 and the plug 70 of the current source. When an earthquake occurs, the noise or sound of the buzzer 72 together with the flickering light of the lighting strap 50 will lead people to move away from the unsafe site.

The lining board of the present invention can be mounted at the foot of the wall or at the foot of wall in the starcase, and is directed to an emergency exist In case a fire occurs, the smoke will release upward and the lighted lining board will similarly lead to a safer site.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A combined structure of a light source and fire-resistant lining board having a bottom recess, operated with a 24V low current and low voltage and LED being employed as light source, characterized in that a transparent rubber strap covers the LED and is elongated which can be bent optionally, a buzzer is positioned between a light source and the current source, and the bottom recess of the fire-resistant lining board contains the LED and the LED is then covered with a transparent external cover by means of engaging peg and engaging slot or protruded peg and recess, the LED produced brightness to cause an ornamental object to be seen and the buzzer assists in alarming the direction of exist to a safer site.
